(19) United States
(12) Patent Application Publication
(10) Pub. No.: US 2022/0091590 A1
(43) Pub. Date: Mar. 24, 2022

(54) FAILURE SIGN DETECTION SYSTEM AND FAILURE SIGN DETECTION METHOD

(71) Applicant: HITACHI, LTD., Tokyo (JP)

(72) Inventor: Tomohiro HANADA, Tokyo (JP)

(21) Appl. No.: 17/417,401

(22) PCT Filed: Mar. 2, 2020
(86) PCT No.: PCT/JP2020/008763

§ 371 Date: Jun. 23, 2021

(30) Foreign Application Priority Data
Mar. 20, 2019 (JP) 2019-053907

(51) Int. Cl. G05B 19/418

(52) U.S. Cl. CPC G05B 19/4184; G05B 19/41885; G05B 19/4183

(57) ABSTRACT

A failure sign detection system 100 includes: a data storage unit 160 that retains data at the time of normal operation of each action, as learning data, with respect to a manufacturing operation of a manufacturing apparatus 2 composed of a plurality of actions; a sensor (acceleration sensor 6) that measures the manufacturing operation of the manufacturing apparatus 2; an action detection unit 110 that detects an action start of each action in the manufacturing operation; a divided data collection unit 180 that divides measured data, which is measured by the acceleration sensor 6, into divided data for each action and collects the divided data; and a data analysis unit 140 that analyzes an abnormality of each action on the basis of a comparison between the divided data and the learning data of each action.

### TECHNICAL FIELD

The present invention relates to a failure sign detection system and a failure sign detection method and is suited for application to a failure sign detection system and failure sign detection method for detecting a failure sign by targeting at a manufacturing apparatus which performs a manufacturing operation composed of a plurality of actions.

### BACKGROUND ART

Conventionally, a wide variety of methods of detecting abnormalities of an apparatus have been devised; and there is known a representative method for such abnormality detection by comparing measured data of a sensor, which is installed in the apparatus, with data of the apparatus in normal operation and detecting and determining an abnormality when any difference(s) between them is found.

For example, PTL 1 discloses a method of analyzing a frequency spectrum obtained by performing Fourier transformation of measured data of an acceleration sensor installed in a manufacturing apparatus, comparing an evaluated value after the analysis with an evaluated value at the time of normal operation, and deciding the life time of the manufacturing apparatus depending on whether a specified condition is satisfied or not.

### CITATION LIST

### Patent Literature

PTL 1: Japanese Patent Application Laid-Open (Kokai) Publication No. 2003-074478

### SUMMARY OF THE INVENTION

### Problems to be Solved by the Invention

However, when the same manufacturing apparatus performs a plurality of different actions, the life time prediction method disclosed by PTL 1 cannot set different comparison conditions to the respective actions. So, there is a problem of degradation of accuracy in detecting abnormalities.

The present invention was devised in consideration of the above-described circumstances and aims at proposing a failure sign detection system and failure sign detection method capable of detecting abnormalities with high accuracy by performing analysis on an action basis even if the manufacturing operation of the manufacturing apparatus is composed of a plurality of actions with different aspects.

### Means to Solve the Problems

In order to solve the above-described problems, provided according to the present invention is a failure sign detection system including: a data storage unit that retains data at the time of normal operation of each action, as learning data, with respect to a manufacturing operation of a manufacturing apparatus composed of a plurality of actions; a sensor that measures the manufacturing operation of the manufacturing apparatus; an action detection unit that detects an action start of each action in the manufacturing operation; a divided data collection unit that divides measured data, which is measured by the sensor, into divided data for each action and collects the divided data; and a data analysis unit that analyzes an abnormality of each action on the basis of a comparison between the divided data and the learning data of each action.

Furthermore, in order to solve the above-described problems, provided according to the present invention is a failure sign detection method including: an advance step of retaining data at the time of normal operation of each action, as learning data, with respect to a manufacturing operation of a manufacturing apparatus composed of a plurality of actions; an action detection step of detecting an action start of each action in the manufacturing operation; a measurement step of measuring the manufacturing operation of the manufacturing apparatus with a specified sensor; a divided data collection step of dividing measured data, which is measured in the measurement step, into divided data for each action and collecting the divided data; and a data analysis step of analyzing an abnormality of each action on the basis of a comparison between the divided data and the learning data of each action.

### Advantageous Effects of the Invention

According to the present invention, abnormalities can be detected on an action basis with high accuracy even if the manufacturing operation of the manufacturing apparatus is composed of a plurality of actions.

### BRIEF DESCRIPTION OF DRAWINGS

FIG. 1 is a block diagram illustrating a hardware configuration example of a failure sign detection system according to a first embodiment of the present invention;

FIG. 2 is a block diagram illustrating a functional configuration example of the failure sign detection system illustrated in FIG. 1;

FIG. 3 is a diagram illustrating a configuration example of a collected data management table;

FIG. 4 is a diagram illustrating a configuration example of a divided data management table;

FIG. 5 is a diagram illustrating a configuration example of an action type management table;

FIG. 6 is a diagram illustrating a configuration example of a learning data management table;

FIG. 7 is a diagram illustrating a configuration example of an analysis result management table;

FIG. 8 is a flowchart illustrating a processing sequence example of data division processing;

FIG. 9 is a diagram for explaining an image of dividing the measured data;

FIG. 10 is a flowchart illustrating a processing sequence example of data analysis processing;

FIG. 11 is a diagram illustrating one example of an analysis result display screen;

FIG. 12 is a block diagram illustrating a functional configuration example of a failure sign detection system according to a second embodiment of the present invention;

FIG. 13 is a diagram illustrating one example of a manufacturing apparatus action log file;

FIG. 14 is a diagram illustrating a configuration example of a collected data management table according to the second embodiment;

FIG. 15 is a flowchart illustrating a processing sequence example of data division processing according to the second embodiment; and

FIG. 16 is a diagram for explaining an image of predicting a failure occurrence day.

### DESCRIPTION OF EMBODIMENTS

Embodiments of the present invention will be explained in detail with reference to the drawings.

### (1) First Embodiment

### (1-1) Configuration of Failure Sign Detection System

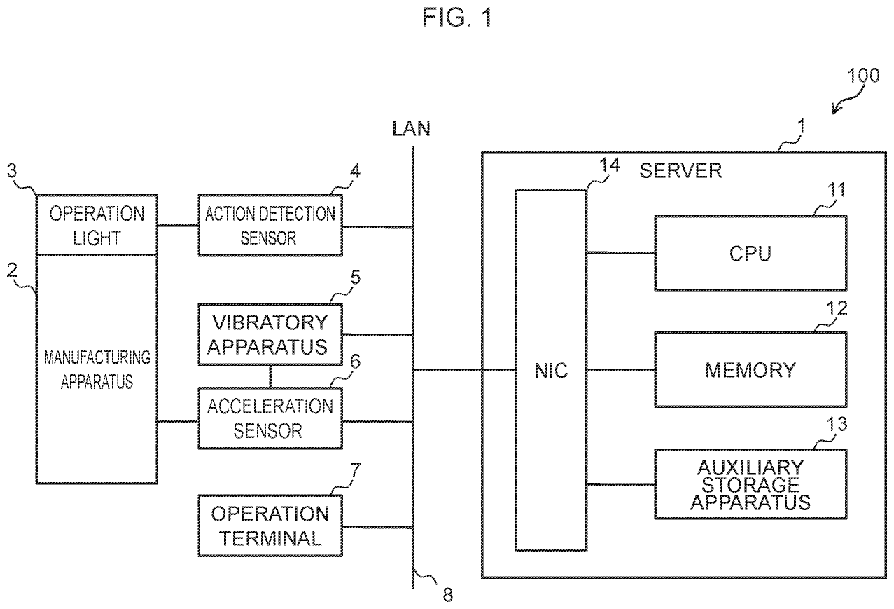

FIG. 1 is a block diagram illustrating a hardware configuration example of a failure sign detection system according to a first embodiment of the present invention.

A failure sign detection system 100 illustrated in FIG. 1: is a system that enables mainly a system to detect a failure sign by detecting the occurrence of an abnormality in a manufacturing operation by a manufacturing apparatus 2; and is configured such that the server 1 is connected with an action detection sensor 4, a vibratory apparatus 5, and an acceleration sensor 6 via a LAN (Local Area Network) 8 in a communicable manner. Furthermore, the server 1 is also connected with a user's operation terminal 7 via the LAN 8 in a communicable manner.

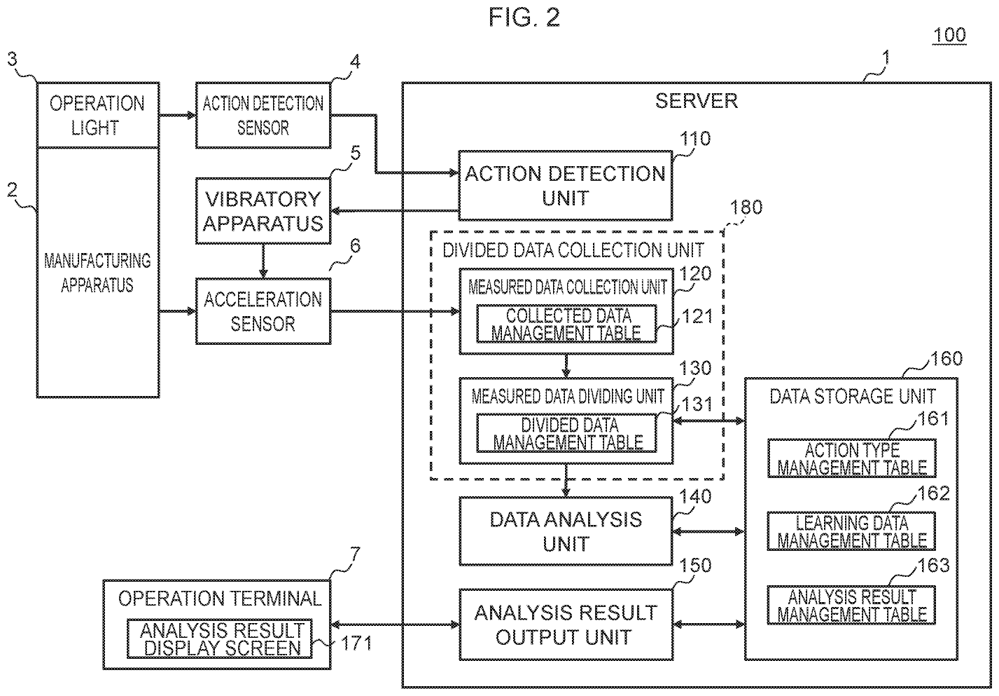

A common server can be used as the server 1 and the server 1 includes a CPU (Central Processing Unit) 11 which is a processor, a memory 12 which is a main storage apparatus, an auxiliary storage apparatus 13, and an NIC (Network Interface Card) 14. With the server 1, as the CPU 11 executes specified programs possessed by the memory 12, specified processing (more specifically, processing for implementing functions of an action detection unit 110, a measured data collection unit 120, a measured data dividing unit 130, a data analysis unit 140, and an analysis result output unit 150 illustrated in FIG. 2) is executed by the failure sign detection system 100. The auxiliary storage apparatus 13 is, for example, HDDs (Hard Disk Drives) and/or SSDs (Solid State Disks), but may be other storage apparatuses. The NIC 14 is a network adapter which enables communication between the server 1 and the outside by connecting to the LAN 8.

Incidentally, the hardware configuration illustrated in FIG. 1 is one example and other configurations may be employed in this embodiment. For example, the auxiliary storage apparatus 13 may be a storage apparatus outside the server 1 and the network type may be other than the LAN. Moreover, FIG. 1 shows the user's operation terminal 7; however, for example, a configuration having a dedicated display device on the server 1 side may be employed.

The manufacturing apparatus 2 is an apparatus for manufacturing products by performing a manufacturing operation composed of a plurality of actions with different aspects and an operation light 3 is attached to the manufacturing apparatus 2. The operation light 3: is a light for reporting an action status of the manufacturing apparatus 2 by, for example, emitting light; and is designed to, for example, turn on the light at a timing to start each action included in the manufacturing operation and turn off the light at a timing to terminate the relevant action.

The action detection sensor 4 is a sensor for detecting the action start of the manufacturing apparatus 2 and is, for example, a color sensor connected to the operation light 3. When the operation light 3 emits the light (for example, turns on the light) which means the start of the relevant action, the action detection sensor 4 detects it and informs the server 1 (the action detection unit 110 described later with reference to FIG. 2) that the action of the manufacturing apparatus 2 is started.

Incidentally, this example is configured such that the operation light 3 reports the action start of the manufacturing apparatus 2 and the action detection sensor 4 detects behaviors of the operation light 3; however, this embodiment is not limited to such configuration and any configuration may be employed as long as the action start by the manufacturing apparatus 2 is reported to the server 1.

The vibratory apparatus 5 is an apparatus which is installed and connected to the acceleration sensor 6 and causes the acceleration sensor 6 to vibrate in accordance with an instruction from the server 1 (the action detection unit 110 described later with reference to FIG. 2). The vibratory apparatus 5 can cause, with its vibrations, breaks to be generated in measured data of the acceleration sensor 6. Incidentally, this example employs the vibratory apparatus 5 as one example of the apparatus capable of causing the breaks to be generated in the above-mentioned measured data; however, in this embodiment, a factor which causes the breaks to be generated in the above-mentioned measured data may be other than vibrations and there is no limitation on the type of the apparatus. For example, it may be an apparatus or the like capable of inputting an electronic signal to the above-mentioned measured data.

The acceleration sensor 6 is a sensor that is attached to the manufacturing apparatus 2 and measures acceleration of the actions of the manufacturing apparatus 2. The measured data which is measured by the acceleration sensor 6 is transmitted to the server 1 (the measured data collection unit 120 described later with reference to FIG. 2).

Incidentally, this example shows the configurations such that the acceleration sensor 6 is attached to the manufacturing apparatus 2 and measures the acceleration and the vibratory apparatus 5 uses vibrations to cause the breaks to be generated in the measured data of the acceleration sensor 6; however, this embodiment is not limited to these configurations. Specifically speaking, the sensor attached to the manufacturing apparatus 2 may be any sensor as long as it is capable of acquiring data which can detect a failure sign (the occurrence of an abnormality) of the manufacturing apparatus 2 and the acquired data shows periodicity; and a current sensor or the like may be used instead of the acceleration sensor 6. Then, the apparatus capable of causing the breaks to be generated in the measured data of the sensor can be changed arbitrarily according to the type of the sensor attached to the manufacturing apparatus 2. For example, if the current sensor is used instead of the acceleration sensor 6, an apparatus capable of switching ON/OFF of an electric current may be used instead of the vibratory apparatus 5.

Although the details will be explained later, by causing the breaks to be generated in the measured data at the timing to start each action of the manufacturing operation in this embodiment, such breaks can be used in data division processing as marks for dividing the measured data on an action basis.

FIG. 2 is a block diagram illustrating a functional configuration example of the failure sign detection system illustrated in FIG. 1. Referring to FIG. 2, the failure sign detection system 100 includes, within the server 1, the action detection unit 110, the measured data collection unit 120, the measured data dividing unit 130, the data analysis unit 140, the analysis result output unit 150, and a data storage unit 160.

Of these components, the data storage unit 160 is implemented by the auxiliary storage apparatus 13 illustrated in FIG. 1; and more specifically, the auxiliary storage apparatus 13 has areas for retaining an action type management table 161, a learning data management table 162, and an analysis result management table 163. On the other hand, other functional components are implemented mainly by the CPU 11 and the memory 12. Then, the memory 12 has areas for retaining a collected data management table 121 registered by the measured data collection unit 120 and a divided data management table 131 registered by the measured data dividing unit 130.

The action detection unit 110 has a function that acquires the measured data by the action detection sensor 4 and detects the action start of the manufacturing apparatus 2 from the acquired measured data. Furthermore, the action detection unit 110 has a function that issues an instruction to the vibratory apparatus 5 to execute a specified vibration action at the detected timing of the action start of the manufacturing apparatus 2. Incidentally, when to start the manufacturing operation (in other words, when to start the first action) is obvious even without inserting a break, so that the action detection unit 110 does not have to issue the instruction to the vibratory apparatus 5 to cause vibrations. Each of the drawings indicated in the explanation of this embodiment illustrates a case where the instruction to cause the vibrations is not given when starting the manufacturing operation.

The measured data collection unit 120 has a function that acquires the measured data by the acceleration sensor 6 attached to the manufacturing apparatus 2 and assigns information such as a serial number or the like of a manufactured product. Moreover, the measured data collection unit 120 has a function that registers the acquired measured data and the assigned serial number or the like in the collected data management table 121.

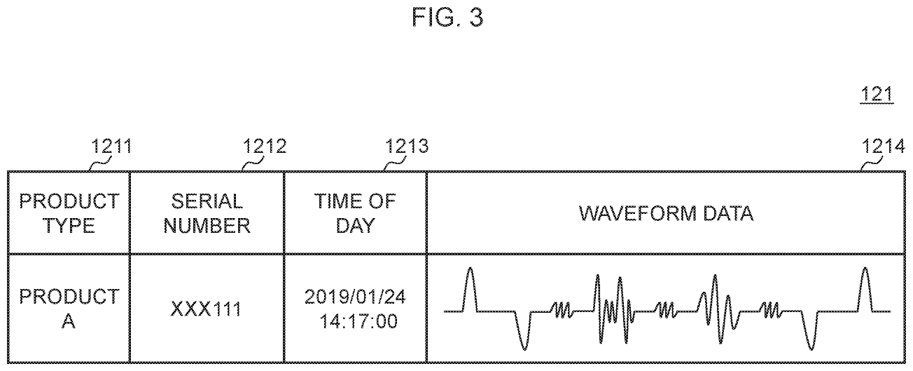

FIG. 3 is a diagram illustrating a configuration example of a collected data management table. The collected data management table 121: is a data table for managing the measured data collected by the measured data collection unit 120; and is configured, as illustrated in FIG. 3, by including a product type 1211, a serial number 1212, a time of day 1213, and waveform data 1214.

In the collected data management table 121, the product type 1211 records the type of a product (such as a product name) manufactured by the targeted manufacturing operation; and the serial number 1212 records a serial number for uniquely identifying the product recorded in the product type 1211. Specifically speaking, the serial number is an identification number which varies for each product. Incidentally, the product type 1211 may be fixed information which is set to the measured data collection unit 120 in advance, be acquired from a manufacturing system (which is not illustrated in the drawings) or the like for managing the entire production line, be input by the user, or be acquired by other methods. The same applies to the serial number 1212.

The time of day 1213 records the time of day when the measured data was measured by the acceleration sensor 6. In the case of FIG. 3, the measurement start time-of-day is recorded; however, for example, times of day from the start of the measurement to the end of the measurement may be recorded. Then, the waveform data 1214 records the measured data as waveform data.

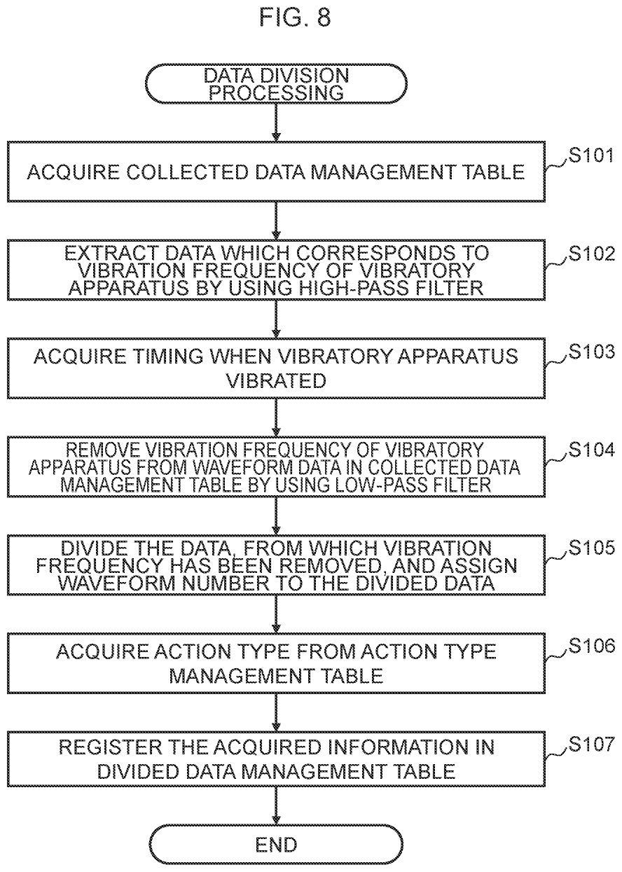

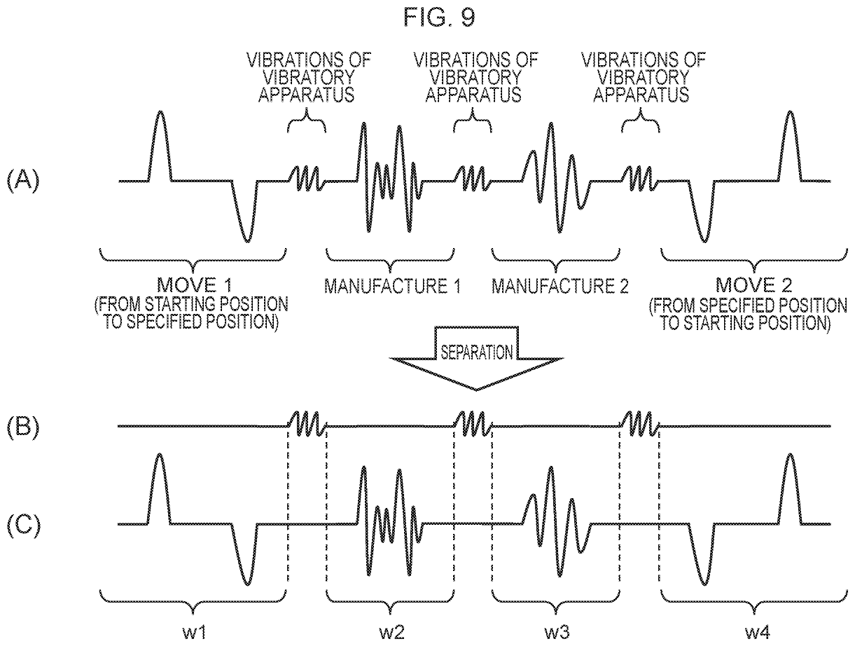

The measured data dividing unit 130 has a function that divides the measured data, which was acquired by the measured data collection unit 120, on an action basis of the manufacturing apparatus 2 and identifies the action type of each divided measured data (waveform data). The measured data which is divided will be hereinafter referred to as the “divided data.” Moreover, the measured data dividing unit 130 has a function that registers the waveform data of the divided data and the identified action type or the like in the divided data management table 131. The above-described processing by the measured data dividing unit 130 will be referred to as “data division processing” and its detailed processing sequence will be explained later with reference to FIG. 8 and FIG. 9.

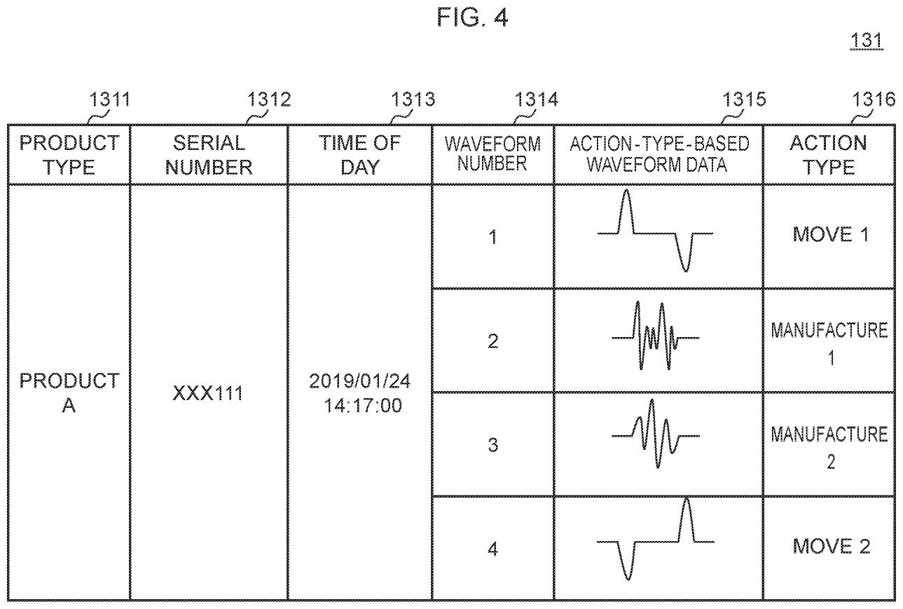

FIG. 4 is a diagram illustrating a configuration example of the divided data management table. The divided data management table 131: is a data table for managing the divided data; and is configured, as illustrated in FIG. 4, by including a product type 1311, a serial number 1312, a time of day 1313, a waveform number 1314, action-type-based waveform data 1315, and an action type 1316.

In the divided data management table 131, information about the measured data which became a target to be divided by the data division processing is recorded in the product type 1311, the serial number 1312, and the time of day 1313. They correspond to the product type 1211, the serial number 1212, and the time of day 1213 in the collected data management table 121 in FIG. 3.

The waveform number 1314 records a consecutive number assigned in chronological order to the measured data (waveform data) divided by the measured data dividing unit 130. The action-type-based waveform data 1315 records waveform data obtained by dividing the waveform data, which is recorded in the collected data management table 121 (the waveform data 1214), on an action basis.

The action type 1316 records an action type of the relevant action, which was then performed, and indicates, by means of the action type of the relevant action, which action of the manufacturing operation was performed when each relevant waveform data was recorded in the action-type-based waveform data 1315.

Under this circumstance, the action type recorded in the action type 1316 can be identified by the measured data dividing unit 130 by referring to the action type management table 161 stored in the data storage unit 160.

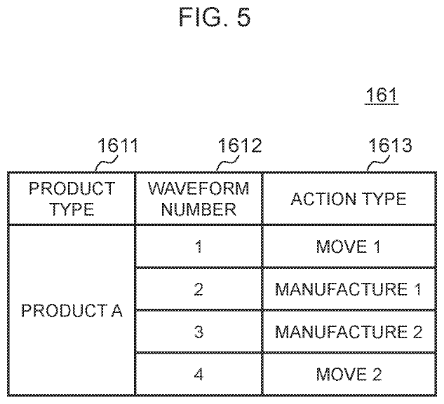

FIG. 5 is a diagram illustrating a configuration example of an action type management table. The action type management table 161: is a data table in which action types of the plurality of actions constituting the manufacturing operation are registered in advance; and is configured, as illustrated in FIG. 5, by including a product type 1611, a waveform number 1612, and an action type 1613.

Specifically, in the action type management table 161 in FIG. 5, an manufacturing operation of “Product A” is composed of four actions; and the action types of the respective actions which are “Move 1,” “Manufacture 1,” “Manufacture 2,” and “Move 2” in chronological order are registered. In this example, “Move 1,” “Manufacture 1,” “Manufacture 2,” and “Move 2” mean actions of respectively different aspects.

Therefore, the measured data dividing unit 130 can identify the action type 1613 corresponding to a combination of the product type 1311 and the waveform number 1314 of the divided data management table 131 (the product type 1611 and the waveform number 1612 of the action type management table 161), as the action type recorded in the action type 1316, by referring to the action type management table 161.

Incidentally, FIG. 2 illustrates a divided data collection unit 180 as a functional unit configured of the measured data collection unit 120 and the measured data dividing unit 130. The divided data collection unit 180 has the function of the measured data collection unit 120 and the function of the measured data dividing unit 130; and, in summary, the divided data collection unit 180 has a function that divides the measured data of the acceleration sensor 6, which measured the manufacturing operation of the manufacturing apparatus 2, into divided data on an action basis and collects the divided data.

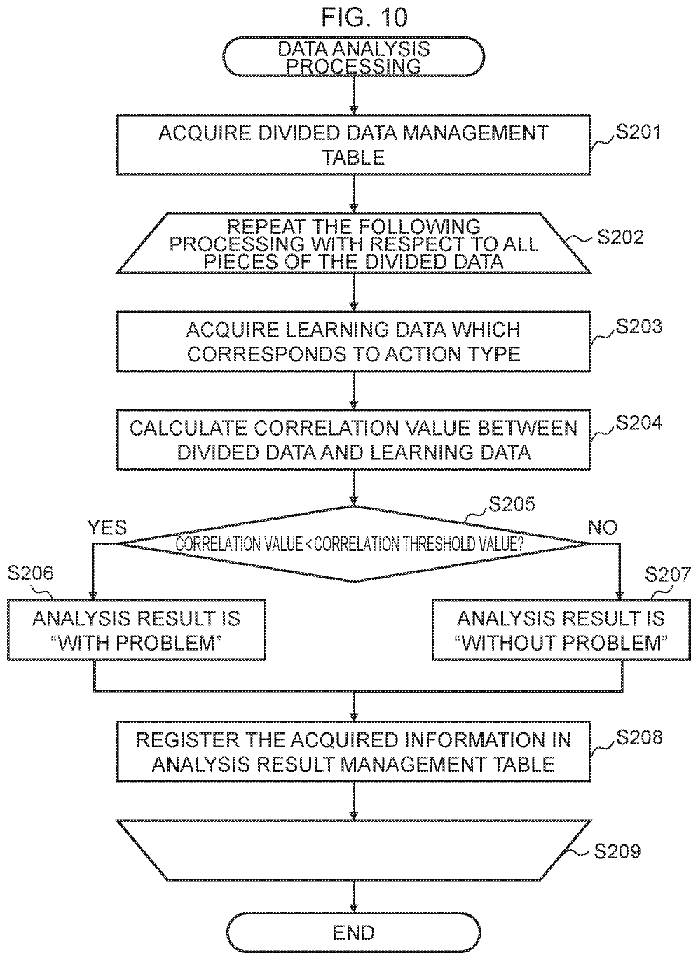

The data analysis unit 140 has a function that compares each divided data divided by the measured data dividing unit 130 (the action-type-based waveform data 1315), with the learning data by using the learning data management table 162, judges whether there is any problem in the relevant action or not by a specified analysis method, and records the analysis result in the analysis result management table 163. Such processing by the data analysis unit 140 will be referred to as “data analysis processing” and its detailed processing sequence will be explained later with reference to FIG. 10.

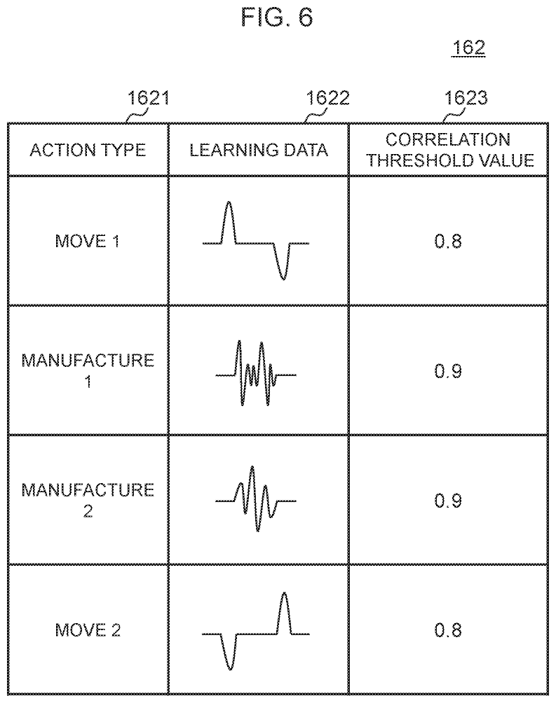

Incidentally, the “specified analysis method” used by the data analysis processing: may be a method for mechanically judging whether there is any abnormality in the action of the manufacturing apparatus 2 or not, in order to detect a failure sign of the manufacturing apparatus 2; and is not limited to a specific analysis method. For example, the “specified analysis method” may be a method for performing the comparison via, for example, a correlation function by using data learned as normal operation in advance (learning data 1622 in FIG. 6), and determining that there is a problem when the found correlation value is smaller than a threshold value (a correlation threshold value 1623 in FIG. 6). Moreover, for example, the “specified analysis method” may be a method for aligning the latest correlation value and past correlation values in chronological order and predicting a failure occurrence day by finding a day when the correlation value becomes smaller than a threshold value, by using a regression formula or an approximate formula. An explanation about the method for predicting the failure occurrence day will be complemented in a second embodiment.

FIG. 6 is a diagram illustrating a configuration example of a learning data management table. The learning data management table 162 is: a data table for managing the learning data, which was learned in advance as data at the time of normal operation, on an action type basis; and is configured, as illustrated in FIG. 6, by including an action type 1621, a learning data 1622, and a correlation threshold value 1623.

The action type 1621 records the action type of each of the actions constituting the manufacturing operation and corresponds to the action types illustrated in FIG. 4 and FIG. 5. The learning data 1622 is learning data for the action indicated by the action type 1621 and waveform data at the time of normal operation is recorded. The correlation threshold value 1623 is a threshold value for the judgment standard used for the data analysis unit 140 to judge whether there is any problem in the action or not, by the specified analysis method by comparing the action-type-based waveform data 1315 with the learning data 1622; and a different value can be set for each action type. The action type 1621 and the learning data 1622 are registered in advance. Regarding the correlation threshold value 1623, a fixed value may be registered in advance or the correlation threshold value 1623 can be set as changeable by the data analysis unit 140 depending on the analysis method.

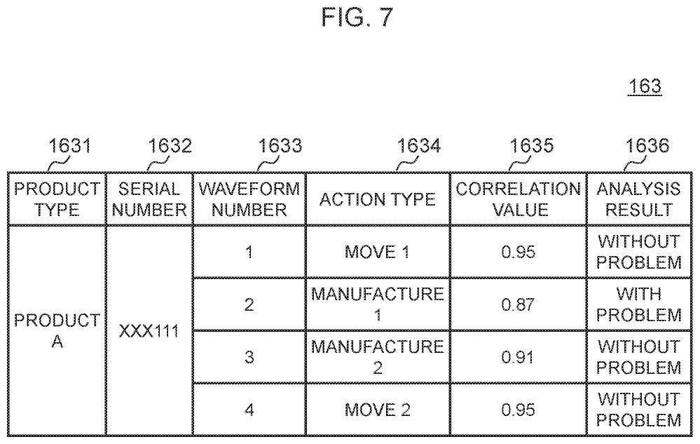

FIG. 7 is a diagram illustrating a configuration example of an analysis result management table. The analysis result management table 163: is a data table for managing the analysis results of the data analysis processing; and is configured, as illustrated in FIG. 7, by including a product type 1631, a serial number 1632, a waveform number 1633, an action type 1634, a correlation value 1635, and an analysis result 1636.

The product type 1631, the serial number 1632, the waveform number 1633, and the action type 1634 record data of items corresponding to those in the divided data management table 131 which is referenced by the data analysis processing. The correlation value 1635 records a correlation value between a waveform of the divided data (the action-type-based waveform data 1315) and a waveform of the learning data (the learning data 1622). The analysis result 1636 records the judgment result of whether any abnormality exists or not with respect to each of the actions constituting the manufacturing operation.

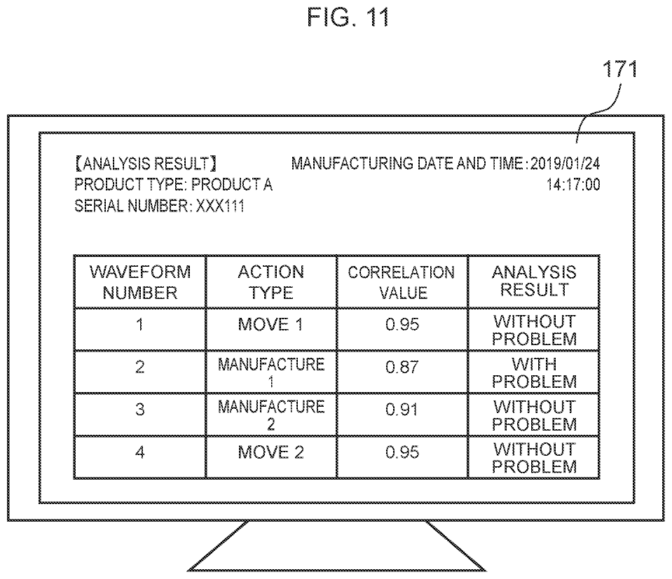

The analysis result output unit 150 has a function that outputs the analysis result of the data analysis processing recorded in the analysis result management table 163 to the user's side. In this example, as one example of the output, the analysis result output unit 150 is designed to be capable of displaying information desired by the user, among the information recorded in the analysis result management table 163, on an analysis result display screen 171 of the operation terminal 7. The details of the output of the analysis result by the analysis result output unit 150 will be explained later with reference to FIG. 11.

Incidentally, in this embodiment, an output form of the analysis result is not limited to the display and, for example, printing and outputting to data files can be adopted as other output forms. Moreover, the output of the analysis result may be executed without requiring the operation by the user and, for example, the analysis result output unit 150 may output the analysis result on a real-time basis during the execution of the manufacturing operation of the manufacturing apparatus 2 or as triggered by an update or registration of the analysis result management table 163 by the data analysis unit 140 at the time of termination of the manufacturing operation.

### (1-2) Failure Sign Detection Method

An explanation will be provided about a method for the failure sign detection system 100 according to this embodiment to detect the occurrence of an abnormality with respect to the manufacturing operation of the manufacturing apparatus 2 (a failure sign detection method).

The manufacturing apparatus 2 manufactures a product(s) by executing the manufacturing operation composed of a plurality of actions with different aspects as mentioned earlier. Then, when each action starts at the manufacturing apparatus 2, the operation light 3 turns on and the action detection sensor 4 detects the light which is turned on. The action detection unit 110 monitors the measured data of the action detection sensor 4 and can detect the start of one action of the manufacturing operation of the manufacturing apparatus 2 by analyzing the measured data of the action detection sensor 4.

When the action detection unit 110 detects the start of an action of the manufacturing apparatus 2 from the measured data of the action detection sensor 4, it issues an instruction to the vibratory apparatus 5 to vibrate at a specified frequency (which should preferably be a frequency different from a main component of a frequency measured in association with the action of the manufacturing apparatus 2) for a certain period of time. When the vibratory apparatus 5 vibrates in accordance with the above-described instruction, the acceleration sensor 6 which measures the acceleration of the action(s) of the manufacturing apparatus 2 also vibrates, so that breaks caused by the above-mentioned vibrations are inserted into the measured data of the acceleration sensor 6 at the timing between the respective actions. Incidentally, when to start the manufacturing operation (in other words, when to start the first action) is obvious even if the break is not inserted; and, therefore, the action detection unit 110 does not have to issue the instruction to the vibratory apparatus 5 to vibrate.

Next, the measured data collection unit 120: acquires the measured data of the acceleration sensor 6 which measured the entire one manufacturing operation by the manufacturing apparatus 2; and registers the measured data together with related information of the acquired measured data in the collected data management table 121. Specifically speaking, the related information registered in the collected data management table 121 is the product type 1211 of a product manufactured by the manufacturing operation, which is the target of the measured data, the serial number 1212 of the relevant product, the time of day 1213 when the measured data was measured, and the waveform data 1214 of the measured data (see FIG. 3).

Subsequently, the measured data dividing unit 130 reads the collected data management table 121 registered by the measured data collection unit 120 and executes the data vision processing on the measured data, thereby registering the divided data, which is obtained by dividing the measured data on an action basis, and its related information in the divided data management table 131.

### (1-2-1) Data Division Processing

FIG. 8 is a flowchart illustrating a processing sequence example of data division processing. Moreover, FIG. 9 is a diagram for explaining an image of dividing the measured data. The data division processing will be explained in detail with reference to FIG. 8 and FIG. 9.

Referring to FIG. 8, the measured data dividing unit 130 firstly acquires the collected data management table 121 from the measured data collection unit 120 (step S101). FIG. 9(A) illustrates the waveform data of the measured data acquired in step S101. Since this waveform data is measured through a sequence of the manufacturing operation, the vibrations of the vibratory apparatus 5, which caused the breaks, were detected at the start of “Manufacture 1,” “Manufacture 2,” and “Move 2,” which are the second and subsequent actions among the four actions constituting the manufacturing operation.

Next, the measured data dividing unit 130 extracts data corresponding to the vibration frequency of the vibratory apparatus 5 from the waveform data, which was acquired in step S101, by using a high-pass filter (step S102). FIG. 9(B) illustrates the waveform data extracted in step S102. You can see from the waveform data in FIG. 9(B) that only the vibrations for the breaks generated by the vibratory apparatus 5 are extracted.

Then, the measured data dividing unit 130 acquires the timing when the vibratory apparatus 5 vibrated, from the data extracted in step S102 (step S103).

Subsequently, the measured data dividing unit 130 removes the vibration frequency of the vibratory apparatus 5 from the waveform data, which was acquired in step S101, by using a low-pass filter (step S104). FIG. 9(C) illustrates the waveform data after the vibration frequency of the vibratory apparatus was removed in step S104. You can see, from the waveform data in FIG. 9(C), that signals for the breaks inserted between the respective actions (vibration components by the vibratory apparatus 5) have been removed and only the measured data for the actions of the manufacturing apparatus 2 are extracted.

Next, the measured data dividing unit 130 divides the data after the removal in step S104 at the vibration timing of the vibratory apparatus 5 as acquired in step S103, and assigns waveform numbers to the divided data in chronological order (step S105). FIG. 9(C) illustrates the waveform data divided in step S105 (the divided data) as “w1” to “w4” and the respective pieces of the divided data correspond to the waveform data divided for the respective actions (the action-type-based waveform data). Then, the waveform numbers “1” to “4” are assigned to the divided data “w1” to “w4” by the processing in step S105.

Then, the measured data dividing unit 130 refers to the action type management table 161 and acquires the product type of the divided data, which was divided in step S105, and the action type corresponding to the waveform number (step S106). Specifically speaking, the product type of the divided data is indicated in the product type 1211 of the collected data management table 121 and the waveform number is assigned in step S105. Then, as illustrated in FIG. 5, the action type 1613 corresponding to a combination of the product type 1611 and the waveform number 1612 is registered in the action type management table 161.

Lastly, the measured data dividing unit 130 registers the information, which was obtained in step S101 to S106, in the divided data management table 131 (step S107) and terminates the data division processing. As the individual items registered in the divided data management table 131 are checked by referring to FIG. 4, the product type 1311, the serial number 1312, and the time of day 1313 are indicated in the collected data management table 121 acquired in step S101. Moreover, the waveform number 1314 and the action-type-based waveform data 1315 are decided in step S105 and the action type 1316 is acquired in step S106.

Incidentally, in the explanation of the above-described data division processing, the high-pass filter is used to extract the vibration frequency of the vibratory apparatus 5 and the low-pass filter is used to remove it; however, this embodiment does not limit what kind of filter to be used and, for example, a band path filter or the like may be used.

The explanation about the failure sign detection method by the failure sign detection system 100 according to this embodiment will be continued. After the data division processing by the measured data dividing unit 130 terminates, the data analysis unit 140 reads the divided data management table registered by the measured data dividing unit 130 and executes data analysis processing on the divided data, thereby judging whether there is any problem in the relevant action or not, on the basis of each action corresponding to the divided data and registering the analysis result in the analysis result management table 163.

### (1-2-2) Data Analysis Processing

FIG. 10 is a flowchart illustrating a processing sequence example of the data analysis processing. The data analysis processing will be explained in detail with reference to FIG. 10.

Referring to FIG. 10, the data analysis unit 140 firstly acquires the divided data management table 131 from the measured data dividing unit 130 (step S201).

Next, the data analysis unit 140 repeats processing from step S203 to S208 while selecting each one piece of data from all the pieces of the divided data recorded in the divided data management table 131 acquired in step S201 (steps S202 to S209).

During this loop processing, the data analysis unit 140 firstly refers to the learning data management table 162 and acquires a record of the learning data (the learning data 1622 and the correlation threshold value 1623) corresponding to the action type (the action type 1316) of the divided data selected in step S202 (step S203).

Then, the data analysis unit 140 calculates a correlation value between the waveform data of the selected divided data (which is retained in the action-type-based waveform data 1315 of the divided data management table 131) and the learning data 1622 acquired in step S203 by using a correlation function used by a predetermined specified analysis method (step S204).

Subsequently, the data analysis unit 140 judges whether or not the correlation value calculated in step S204 is smaller than the correlation threshold value 1623 acquired in step S203 (step S205). If the correlation value is smaller than the correlation threshold value (YES in step S205), the data analysis unit 140 determines that the analysis result of the selected divided data is “with problem (abnormal)” (step S206). On the other hand, if the correlation value is equal to or larger than the correlation threshold value in step S205 (NO in step S205), the data analysis unit 140 determines that the analysis result of the selected divided data is “without problem (normal)” (step S207).

Then, the data analysis unit 140 registers the information about the selected divided data, which were obtained in step S201 to S207, in the analysis result management table 163 (step S208). As the individual items registered in the analysis result management table 163 are checked by referring to FIG. 7, the product type 1631, the serial number 1632, the waveform number 1633, and the action type 1634 are indicated in the divided data management table 131 acquired in step S201. Moreover, the correlation value 1635 is calculated in step S204 and the analysis result 1636 is judged in step S206 or S207.

The data analysis unit 140: can complete the analysis result management table 163 with respect to all the pieces of the divided data by repeating the above-described processing from step S203 to step S208 on all the pieces of the divided data as targets; and then terminates the data division processing.

As a result of the data analysis processing executed by the data analysis unit 140 as described above, the analysis results of the divided data are registered in the analysis result management table 163, so that the analysis result output unit 150 can thereafter output the analysis result of the data analysis processing with respect to the manufacturing operation upon the user's request.

Under this circumstance, the output of the analysis result by the analysis result output unit 150 will be explained. When the user refers to the content of the analysis result management table 163 from the operation terminal 7 connected to the LAN 8, the user firstly inputs the product type and the serial number on a screen such as a browser of the operation terminal 7 and delivers the input information to the analysis result output unit 150. Then, the analysis result output unit 150 searches the analysis result management table 163, which is retained by the data storage unit 160, for the relevant information on the basis of the information received from the operation terminal 7 and returns the information to be displayed on the screen to the operation terminal 7. As a result, the operation terminal 7 displays the information of the analysis result management table 163 on the analysis result display screen 171 and the user can check the information.

FIG. 11 is a diagram illustrating one example of an analysis result display screen. The analysis result display screen 171 in FIG. 11 is a display example of a case where the product type “Product A” and the serial number “XXX111” are input by the user; and information of the waveform number 1633, the action type 1634, the correlation value 1635, and the analysis result 1636 of the analysis result management table 163 illustrated in FIG. 7 is displayed as the analysis result corresponding to the above-mentioned input information.

Incidentally, the analysis result display screen 171 in FIG. 7 also displays the “manufacturing date and time” other than the above-mentioned information; however, it becomes possible for the analysis result output unit 150 to output this “manufacturing date and time” by, for example, providing the item “manufacturing date and time” in the analysis result management table 163, acquiring the time of day from the time of day 1313 of the divided data management table 131 in step S208 of the data analysis processing, and registering the acquired time of day in the above-mentioned item.

Specifically speaking, regarding the manufacturing operation for “Product A” with the serial number “XXX111” on the analysis result display screen 171 illustrated in FIG. 11, only the analysis result of the second action “Manufacture 1” is “with problem” and the occurrence of abnormality regarding that action is indicated. Under this circumstance, the user can accurately check whether the product has any defect or not, by checking product parts manufactured by the action regarding which the abnormality has been detected.

Under this circumstance, the data analysis processing illustrated in FIG. 10 uses the correlation threshold value 1623 of the learning data management table 162 as the judgment standard for judging whether or not there is any problem (normal/abnormal) with respect to each action in step S205; and this correlation threshold value 1623 can be set arbitrarily for each action. Specifically speaking, if the value of the correlation threshold value 1623 is set to be high, the normal/abnormal judgment standard becomes strict and any abnormality in each action of the manufacturing apparatus 2 can be detected with high accuracy at a stage before the manufacturing apparatus 2 fails due to, for example, a malfunction. Similarly, also in a case where other analysis methods are adopted, the normal/abnormal judgment standard can be set arbitrarily. Therefore, if any abnormality of the action is output as the analysis result of the data analysis processing, which used the strict judgment standard, on the analysis result display screen 171, the user can recognize that, for example, a part or control of the manufacturing apparatus 2 regarding the action, in which the abnormality has been detected, has a failure sign.

If the failure sign detection system 100 according to this embodiment is employed as explained above and when the manufacturing operation of the manufacturing apparatus 2 is composed of a plurality of actions with different aspects, the occurrence of an abnormality can be detected on an action basis with high accuracy and the action in which the abnormality has occurred can be identified by comparing the divided data based on the measured data with the learning data at the time of normal operation. Particularly, when comparing the action-based divided data with the learning data, a different comparison condition can be set for each action by, for example, changing the correlation threshold value for each action, so that the accuracy in detecting abnormalities can be enhanced even if the aspects of the respective actions are of different types.

Furthermore, if the failure sign detection system 100 according to this embodiment is employed even when the manufacturing operation of the manufacturing apparatus 2 is composed of a plurality of actions with different aspects, the action in which an abnormality has occurred can be detected with high accuracy, so that a failure sign in the manufacturing apparatus 2 can be detected and the failure occurrence location can be narrowed down.

Moreover, this embodiment is configured so that each one of the server 1, the action detection sensor 4, and the acceleration sensor 6 which constitute the failure sign detection system 100 is attached to the manufacturing apparatus 2 or installed outside the manufacturing apparatus 2, and the vibratory apparatus 5 is attached to the acceleration sensor 6. Specifically speaking, the failure sign detection system 100 according to this embodiment can detect the failure sign of the manufacturing apparatus 2 without making any changes to the existing manufacturing apparatus 2 and is highly versatile and convenient.

### (2) Second Embodiment

A failure sign detection system 200 according to a second embodiment of the present invention will be explained by mainly focusing on the differences from the failure sign detection system 100 according to the first embodiment. Therefore, regarding any configurations, data, processing, and so on which are common with those of the first embodiment, a detailed explanation about them is omitted.

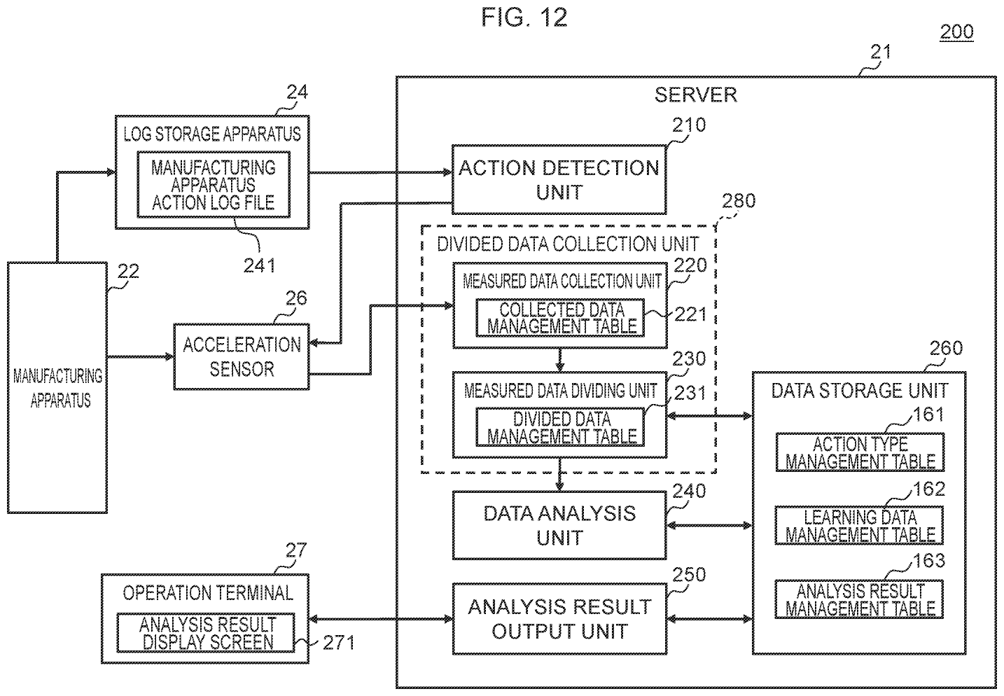

FIG. 12 is a block diagram illustrating a functional configuration example of the failure sign detection system according to the second embodiment of the present invention. The configuration of the failure sign detection system 200 illustrated in FIG. 12 will be explained in comparison with FIG. 1.

Firstly, the operation light 3 and the action detection sensor 4 which are illustrated in FIG. 1 are not installed in the manufacturing apparatus 22 illustrated in FIG. 12; and a log storage apparatus 24 is connected instead. Moreover, the vibratory apparatus 5 illustrated in FIG. 1 is also unnecessary in the second embodiment. Incidentally, a manufacturing operation of a manufacturing apparatus 22 is composed of a plurality of actions with different aspects in the same manner as the manufacturing apparatus 2 in FIG. 1; and as specific actions, it is assumed in the same manner as in the first embodiment that the actions “Move 1,” “Manufacture 1,” “Manufacture 2,” and “Move 2” are executed in the order listed above.

The log storage apparatus 24 is a storage apparatus which acquires an action log of the manufacturing apparatus 22 and records it in a manufacturing apparatus action log file 241; and a message indicating the content of an event is output to the manufacturing apparatus action log file 241 at the timing when the event such as an action start or an action termination of the manufacturing apparatus 22 occurs.

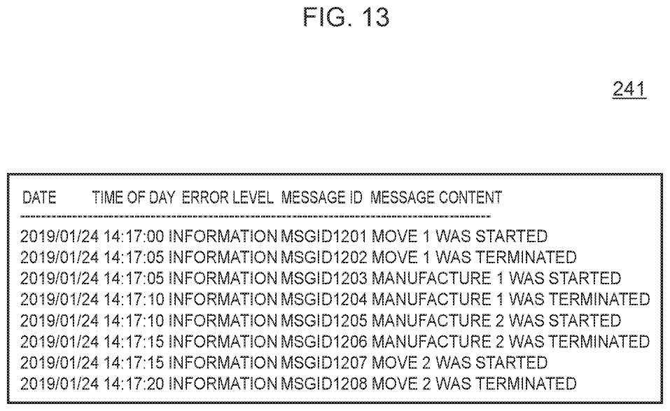

FIG. 13 is a diagram illustrating one example of the manufacturing apparatus action log file. In a case of FIG. 13, the manufacturing apparatus action log file 241 records a date, a time of day, an error level, a message ID, and message content. The “date” and the “time of day” mean the occurrence date and time of the event for which the relevant message was output; and the “error level” means a classification of the message. Moreover, the “message ID” is an identifier of the message; and the “message content” represents the content of the event.

Incidentally, in the second embodiment, the component which is required on the manufacturing apparatus 2 side is not limited to the above-described log storage apparatus 24, but any component may be employed as long as it is capable of recognizing the timing of the action start of the manufacturing apparatus 2 on a real-time basis and reporting that timing to the server 21.

The failure sign detection system 200 includes, as illustrated in FIG. 12, an action detection unit 210, a measured data collection unit 220, a measured data dividing unit 230, a data analysis unit 240, an analysis result output unit 250, and a data storage unit 260 within a server 21.

The action detection unit 210 has a function that monitors the message ID or the message content of the manufacturing apparatus action log file 241 stored in the log storage apparatus 24 and detects the action start of the manufacturing apparatus 22 on the basis of the output of a message indicating the action start of the manufacturing apparatus 22 to the manufacturing apparatus action log file 241. Accordingly, in the second embodiment, the devices such as the operation light 3 and the action detection sensor 4 in the first embodiment become no longer necessary.

Furthermore, the action detection unit 210 has a function that generates breaks for dividing the measured data of the acceleration sensor 26 on an action basis by switching ON/OFF of a measurement status of the acceleration sensor 26 at the timing when detecting the action start of the manufacturing apparatus 22. More specifically regarding the above-described function, the action detection unit 210 issues an instruction to set the measurement status of the acceleration sensor 26 to an OFF state once at the timing when detecting the start of each action of the manufacturing operation, and then switch to an ON sate. Under this circumstance, the acceleration sensor 26: is a sensor which is attached to the manufacturing apparatus 22 and measures acceleration of the actions of the manufacturing apparatus 22; and changes an output destination file of the measured data to another file every time the measurement status is switched according to the instruction from the action detection unit 210. As a result, the acceleration sensor 26 acquires the measured data into different files on an action basis of the manufacturing operation and this action-based measured data is transmitted to the server 21 (the measured data collection unit 220). By having the above-described configuration, the vibratory apparatus 5 in the first embodiment becomes no longer necessary in the second embodiment.

The measured data collection unit 220 has a function, which is similar to that of the measured data collection unit 120 in FIG. 1, that collects the measured data by the acceleration sensor 26 and registers the collected measured data, together with information such as the serial number of a manufactured product, in the collected data management table 221. However, since the measured data collected by the measured data collection unit 220 is already in a state of the divided data which have been divided on an action basis, the configuration of a collected data management table 221 has some difference from the collected data management table 121 in the first embodiment.

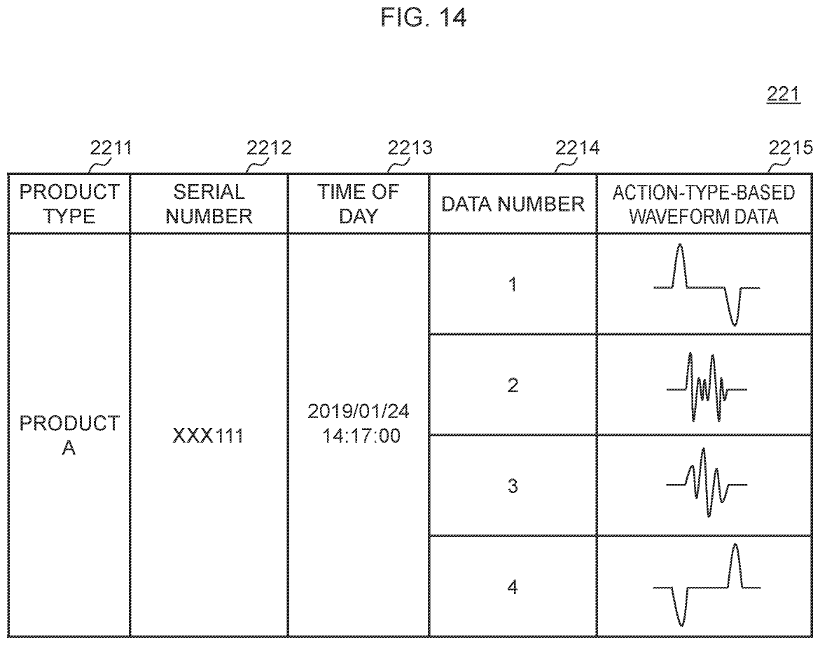

FIG. 14 is a diagram illustrating a configuration example of the collected data management table according to the second embodiment. The collected data management table 221 is configured, as illustrated in FIG. 14, by including a product type 2211, a serial number 2212, a time of day 2213, a data number 2214, and an action-type-based waveform data 2215. As compared to the collected data management table 121 illustrated in FIG. 3 in the first embodiment, you can see that the data number 2214 is added. The data number 2214 is a consecutive number which is assigned by the measured data collection unit 220 to the measured data collected from the acceleration sensor 26 in chronological order. The action-type-based waveform data 2215 is waveform data of the measured data; and since the measured data has been output to different files on an action basis as mentioned earlier, so that the relevant waveform data can be also considered as the action-type-based waveform data. Incidentally, other items of the collected data management table 221 are similar to the items with the same item names of the collected data management table 121, so that an explanation about them is omitted.

The measured data dividing unit 230 has a function that identifies an action type with respect to the measured data acquired by the measured data collection unit 220 and registers the identified action type in the divided data management table 231. Incidentally, since the measured data acquired by the measured data collection unit 220 (in other words, the measured data registered in the collected data management table 221) has already been divided on an action basis as explained earlier, the processing executed by the measured data dividing unit 230 (data division processing) has some difference from the data division processing in the first embodiment (see FIG. 3).

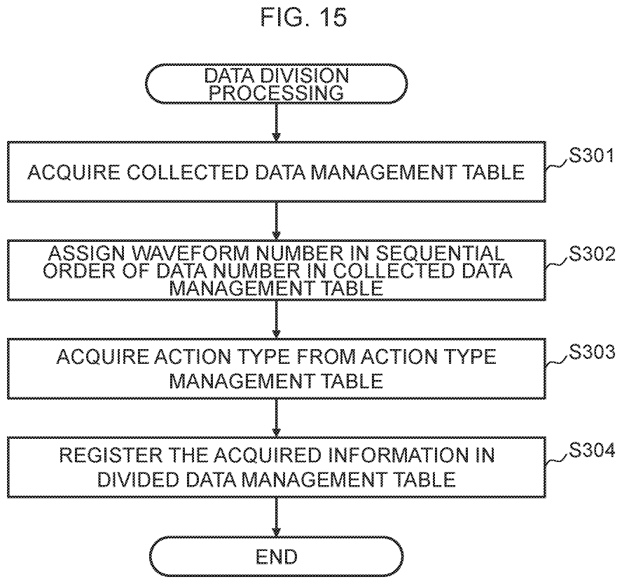

FIG. 15 is a flowchart illustrating a processing sequence example of data division processing according to the second embodiment.

Referring to FIG. 15, the measured data dividing unit 230 firstly acquires the collected data management table 221 from the measured data collection unit 220 (step S301). This processing is similar to the processing in step S101 in FIG. 3.

Next, the measured data dividing unit 230 assigns the waveform number to the measured data in the sequential order of the data number 2214 in the collected data management table 221 acquired in step S301 (step S302). Under this circumstance, the measured data has already been sectioned on an action basis, so that the processing of the measured data by using the filters is no longer necessary. Therefore, the measured data dividing unit 230 can acquire the measured data which is divided on an action basis (that is, the divided data) with certainty without considering, for example, the frequency of the action(s) of the manufacturing apparatus 22.

Then, the measured data dividing unit 230 refers to the action type management table 261 and acquires the product type of the divided data and the action type corresponding to the waveform number (step S303). This processing is similar to the processing in step S106 in FIG. 3. The configuration of the action type management table 261 is similar to that of the action type management table 161 illustrated in FIG. 5, so that a detailed explanation about them is omitted.

Then lastly, the measured data dividing unit 230 registers the information obtained in steps S301 to S303 in the divided data management table 231 (step S304) and terminates the data division processing. This processing is similar to the processing in step S107 in FIG. 3. Moreover, the configuration of the divided data management table 231 is similar to that of the divided data management table 131 in FIG. 4, so that a detailed explanation about them is omitted.

Incidentally, FIG. 12 illustrates a divided data collection unit 280 as a functional unit which is configured of the measured data collection unit 220 and the measured data dividing unit 230, in the same manner as the divided data collection unit 180 illustrated in FIG. 2 in the first embodiment. The divided data collection unit 280: has the function of the measured data collection unit 220 and the function of the measured data dividing unit 230; and, in summary, has a function that divides the measured data of the acceleration sensor 26, which measured the manufacturing operation of the manufacturing apparatus 22, into the divided data on an action basis and collects the divided data.

After the data division processing by the measured data dividing unit 230 terminates, the data analysis unit 240 has a function that: reads the divided data management table 231 registered by the measured data dividing unit 230; judges whether there is any problem in the relevant action on an action basis corresponding to the divided data by executing the data analysis processing on the divided data with reference to the learning data management table 262; and registers the analysis result in the analysis result management table 263. The data analysis processing by the data analysis unit 240 may be recognized as processing similar to the data analysis processing by the data analysis unit 140 in the first embodiment, so that a detailed explanation about them is omitted. Moreover, the configurations of the learning data management table 262 and the analysis result management table 263 are respectively similar to those of the learning data management table 162 illustrated in FIG. 6 and the analysis result management table 163 illustrated in FIG. 7, so that a detailed explanation about them is omitted.

Then, the analysis result output unit 250 has a function that outputs the analysis result of the data analysis processing recorded in the analysis result management table 263 to the user's side. The analysis result display screen 271 illustrated in FIG. 12 is one aspect of the output by the analysis result output unit 250; and is where in response to a request from the user, the analysis result output unit 250 displays, on the operation terminal 7 side, information corresponding to the request from among the information recorded in the analysis result management table 163. A specific display screen of the analysis result display screen 271 may be considered to be similar to the analysis result display screen 171 illustrated in FIG. 11.

Under this circumstance, an explanation about a method for predicting a failure occurrence day will be complemented as one example of the analysis method which can be used for the data analysis processing. Incidentally, the analysis method explained below can be also adopted in the first embodiment.

In the data analysis processing, the data analysis unit 240 calculates a correlation value between learning data which was learned as normal operation in advance (for example, the learning data 1622 in FIG. 6) and the latest measured data (the divided data) by using a correlation function (see FIG. 10). Under this circumstance, let us assume that when predicting the failure occurrence day of the manufacturing apparatus 22, correlation values which were calculated in the same manner at the time of the manufacturing operation of the manufacturing apparatus 22 in the past are recorded in the data storage unit 260. Under this circumstance, the data analysis unit 240 aligns the latest correlation value and the past correlation values in chronological order and draws an approximate line. Then, the data analysis unit 240 can predict the day when this approximate line becomes smaller than a specified threshold value (a correlation threshold value) as a failure occurrence day. The failure occurrence day which is decided in the above-described manner can be considered as a more specific detection result of the failure sign of the manufacturing apparatus 22.

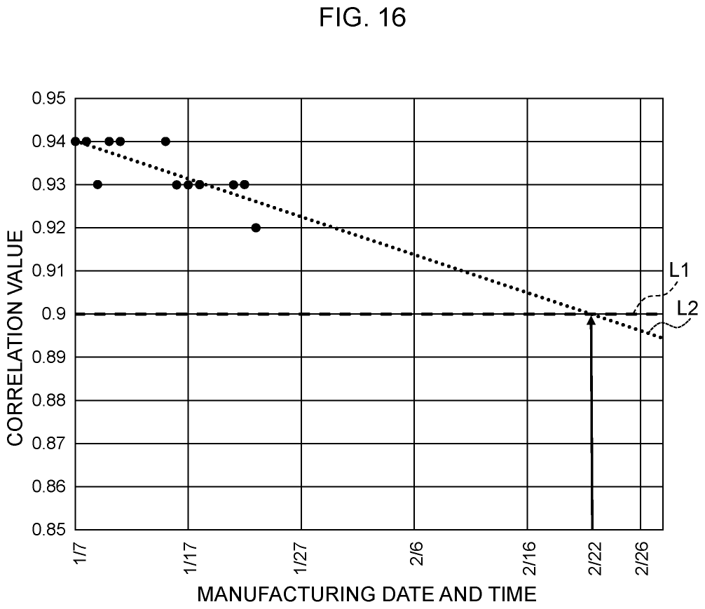

FIG. 16 is a diagram for explaining an image of predicting the failure occurrence day. Referring to FIG. 16, a vertical axis represents a correlation value and a horizontal axis represents a manufacturing date and time; and the latest correlation value and the past correlation values are plotted with black dots and their approximate line L1 is indicated. Moreover, in FIG. 16, L2 represents a correlation threshold value which is set in advance together with the learning data and L2 is set as “0.9” as an example.

Generally, as the manufacturing apparatus 22 repeats the manufacturing operation and time passes, the learning data and the measured data deviate from each other and the correlation value decreases and an inclination of the approximate line L1 based on the correlation value thereby becomes negative. Therefore, even if no abnormality of the action(s) is detected in the latest measured data, the approximate line L1 will become smaller than the correlation threshold value L2 at some point in the future and that day will be predicted as the failure occurrence day. In other words, the data analysis unit 240 can predict the timing when a predicted value resulting from the transition which is the approximate line L1 of the correlation value becomes smaller than the specified threshold value (the correlation threshold value L2), as failure occurrence time. Specifically speaking, in the case of FIG. 16, “2/22” is a failure occurrence day. Incidentally, although it is omitted in FIG. 16, not only the date, but also the time can be predicted.

Then, if the failure occurrence day is predicted by the data analysis processing, the data analysis unit 240 also records the failure occurrence day in the analysis result management table 263. By doing so, the analysis result output unit 250 can present the prediction result of the failure occurrence day of the manufacturing apparatus 22 to the user. In this case, the user can recognize, for example, whether any part or control of which action of the manufacturing operation by the manufacturing apparatus 22 seems to fail or not, by checking the analysis result of which action the prediction result of the failure occurrence day is based on.

Consequently, if the failure sign detection system 200 according to the second embodiment is employed, the following advantageous effects can be further obtained in addition to the advantageous effects obtained in the first embodiment.

Firstly, in the second embodiment, the measured data which measured the manufacturing operation of the manufacturing apparatus 22 can be divided on an action basis without using the vibratory apparatus and it is also unnecessary to cut out the waveforms by means of, for example, the high-pass filter or the low-pass filter. Therefore, the failure sign detection system 200 according to the second embodiment can acquire the waveform data as the divided data from a wide variety of types of the target manufacturing apparatus 22 with certainty without considering the operation frequency, etc. of the manufacturing apparatus 22.

Moreover, in the second embodiment, the action detection unit 210 detects the action start of the manufacturing apparatus 22 on the basis of the action log (the manufacturing apparatus action log file 241) without using sensors (the operation light 3 or the action detection sensor 4), so that the failure sign detection system 200 can judge whether or not there is any abnormality in the action(s) of the manufacturing apparatus 22, without constraints by a surrounding environment of the manufacturing apparatus 22 such as brightness inside a factory, and detect a failure sign.

Incidentally, the present invention is not limited to the aforementioned embodiments, but includes various variations. For example, the aforementioned embodiments have been explained in detail in order to explain the present invention in an easily comprehensible manner and are not necessarily limited to the embodiment having all the configurations explained above. Moreover, part of the configuration of a certain embodiment can be replaced with the configuration of another embodiment and the configuration of another embodiment can be added to the configuration of a certain embodiment. Furthermore, another configuration can be added to, deleted from, or replaced with part of the configuration of each embodiment.

Furthermore, each of the aforementioned configurations, functions, processing units, processing means, etc. may be implemented by hardware by, for example, designing part or all of such configurations, functions, processing units, and processing means by using integrated circuits or the like. Moreover, each of the aforementioned configurations, functions, etc. may be implemented by software by processors interpreting and executing programs for realizing each of the functions. Information such as programs, tables, and files for realizing each of the functions may be retained in memories, storage devices such as hard disks and SSDs, or storage media such as IC cards, SD cards, and DVDs.

Furthermore, control lines and information lines which are considered to be necessary for the explanation are illustrated in the drawings; however, not all control lines or information lines are necessarily indicated in terms of products. Practically, it may be assumed that almost all components are connected to each other.

### REFERENCE SIGNS LIST

1, 21: server
2, 22: manufacturing apparatus
3: operation light
4: action detection sensor
5: vibratory apparatus
6, 26: acceleration sensor
7, 27: operation terminal
8: LAN
11: CPU
12: memory
13: auxiliary storage apparatus
14: NIC
24: log storage apparatus
100, 200: failure sign detection system
110, 210: action detection unit
120, 220: measured data collection unit
121, 221: collected data management table
130, 230: measured data dividing unit
131, 231: divided data management table
140, 240: data analysis unit
150, 250: analysis result output unit
160, 260: data storage unit
161, 261: action type management table
162, 262: learning data management table
163, 263: analysis result management table
171, 271: analysis result display screen
180, 280: divided data collection unit
241: manufacturing apparatus action log file

1. A failure sign detection system comprising:
a data storage unit that retains data at the time of normal operation of each action, as learning data, with respect to a manufacturing operation of a manufacturing apparatus composed of a plurality of actions;
a sensor that measures the manufacturing operation of the manufacturing apparatus;
an action detection unit that detects an action start of each action in the manufacturing operation;
a divided data collection unit that divides measured data, which is measured by the sensor, into divided data for each action and collects the divided data; and
a data analysis unit that analyzes an abnormality of each action on the basis of a comparison between the divided data and the learning data of each action.

2. The failure sign detection system according to claim 1, further comprising an analysis result output unit that outputs an analysis result by the data analysis unit.

3. The failure sign detection system according to claim 1,
wherein upon the comparison between the divided data and the learning data of each action, the data analysis unit is capable of analyzing the abnormality of each action by using a different judgment standard for each action.

4. The failure sign detection system according to claim 1,
wherein the data analysis unit judges whether the abnormality exists in the action or not, on the basis of a correlation value between the divided data and the learning data of the action.

5. The failure sign detection system according to claim 1,
wherein the data analysis unit manages a transition of the correlation value between the divided data and the learning data of the action and predicts failure occurrence time as timing when a predicted value based on the transition becomes smaller than a specified threshold value.

6. The failure sign detection system according to claim 1,
wherein each action of the manufacturing apparatus is indicated by a color sensor, the action detection unit detects the action start of each action on the basis of light emission of the color sensor.

7. The failure sign detection system according to claim 1,
further comprising a vibratory apparatus attached to the sensor,
wherein the action detection unit causes the vibratory apparatus to vibrate at a timing when it detects the action start of each action, thereby generating a break between the actions to the measured data acquired by the sensor; and
wherein the divided data collection unit divides the measured data into the divided data for each action on the basis of the break included in the measured data.

8. The failure sign detection system according to claim 7,
wherein the divided data collection unit:
uses a high-pass filter to extract data which corresponds to a frequency of the vibratory apparatus from waveform data of the measured data, thereby acquiring vibration timing of the vibratory apparatus; and
uses a low-pass filter to delete the data which corresponds to the frequency of the vibratory apparatus from the waveform data of the measured data, thereby obtaining the divided data by dividing the waveform data after the deletion at the vibration timing of the vibratory apparatus.

9. The failure sign detection system according to claim 1,
wherein when an action log of the manufacturing apparatus is recorded, the action detection unit detects the action start of each action by monitoring the action log on a real-time basis.

10. The failure sign detection system according to claim 1,
wherein the action detection unit issues an OFF/ON instruction to the sensor to acquire the measured data on the basis of the detection of the action start of each action; and
wherein the sensor makes the measured data acquired in different output destination files every time the sensor receives the OFF/ON instruction from the action detection unit.

11. The failure sign detection system according to claim 1,
wherein a sequential execution order of the respective actions in the manufacturing operation and an action type of each action are registered in the data storage unit in advance; and
wherein the divided data collection unit associates the sequential execution order and the action type, which are registered in the data storage unit, with the divided data according to a sequential order for collecting the divided data.

12. A failure sign detection method comprising:
an advance step of retaining data at the time of normal operation of each action, as learning data, with respect to a manufacturing operation of a manufacturing apparatus composed of a plurality of actions;
an action detection step of detecting an action start of each action in the manufacturing operation;
a measurement step of measuring the manufacturing operation of the manufacturing apparatus with a specified sensor;
a divided data collection step of dividing measured data, which is measured in the measurement step, into divided data for each action and collecting the divided data; and
a data analysis step of analyzing an abnormality of each action on the basis of a comparison between the divided data and the learning data of each action.

13. The failure sign detection method according to claim 12,
wherein upon the comparison between the divided data and the learning data of each action in the data analysis step, the abnormality of each action can be analyzed by using a different judgment standard for each action.

14. The failure sign detection method according to claim 12,
wherein in the data analysis step, whether the abnormality exists in the action or not can be judged on the basis of a correlation value between the divided data and the learning data of the action.

15. The failure sign detection method according to claim 12,
wherein in the data analysis step, a transition of the correlation value between the divided data and the learning data of the action is managed and failure occurrence time is predicted as timing when a predicted value based on the transition becomes smaller than a specified threshold value.
